(19) United States
(12) Patent Application Publication
(10) Pub. No.: US 2011/0063726 A1
(43) Pub. Date: Mar. 17, 2011

(54) Interference filters for viewing anaglyphs

(76) Inventor: Monte Jerome Ramstad, Cannon Falls, MN (US)

(21) Appl. No.: 12/655,981

(22) Filed: Jan. 11, 2010

Related U.S. Application Data
(60) Provisional application No. 61/276,507, filed on Sep. 12, 2009.

(51) Int. Cl. G02B 27/22

(52) U.S. Cl. 359/464

(57) ABSTRACT

This invention provides apparatus for viewing anaglyphic stereoscopic images with color filters comprising polymer interference films. The interference films may be mounted in lightweight paper frames or rigid frames. The interference films may have a curved profile in order to reduce reflections into a user's eyes. The interference films may be laminated to a substrate. The viewing apparatus may comprise adsorption films in order to block primary colors and attenuate primary colors reflected into a user's eyes.

### CROSS-REFERENCE TO RELATED APPLICATIONS

This application claims the priority benefit of provisional patents 61/204,344 and 61/276,507 and provisional patent titled “Dual Band White LED and Filters for Stereoscopic Signage” filed on Apr. 4, 2009 by inventor Monte Jerome Ramstad.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

Stereoscopic images generally consist of two images that are related by a small change in the lateral perspective. When viewed through an enabling apparatus, stereoscopic images may provide the perception of stereoscopic depth. Anaglyphs are stereoscopic images wherein different sets of primary colors are used to render the first and second images of the stereo pair. Usually, the spectra of the first and second images do not overlap significantly. Then the first and second images may be viewed selectively using two complementary color viewing filters. The first viewing filter F₁ may be used to view the first image while the second viewing filter F₂ may be used to view the second image. The first filter substantially transmits the primary colors of the first image and blocks the primary colors of the second image. The second filter substantially transmits the primary colors of the second image and blocks the primary colors of the first image.

Anaglyphs are often rendered in three primary colors where the first image is rendered in two primary colors while the second image is rendered in one primary color. In red/cyan anaglyphs, the first image is rendered in green and blue primary colors while the second image is rendered in a red primary color. Other types of anaglyphs include blue/yellow and green/magenta anaglyphs. Herein these anaglyphs are called three-color anaglyphs. Three-color anaglyphs are often used to display stereoscopic images due to their relatively low cost and wide compatibility with display devices.

In the case of red/cyan anaglyphs, an ideal cyan viewing filter may transmit light with wavelengths shorter than about 590 nm and block wavelengths longer than about 590 nm. An ideal red viewing filter may transmit light with wavelengths longer than about 590 nm and block light with wavelength shorter than about 590 nm.

In the case of green/magenta anaglyphs, an ideal magenta viewing filter may transmit light with wavelengths longer than about 590 nm and light with wavelengths shorter than about 480-500 nm and block light with wavelengths longer than about 490-500 nm and shorter than about 590 nm. An ideal green viewing filter may transmit light with longer than about 480-500 nm and shorter than about 590 nm and block light with wavelengths longer than about 590 nm and light with wavelengths shorter than about 480-500 nm.

In the case of blue/yellow anaglyphs, an ideal yellow filter may transmit light with wavelengths longer than about 480-500 nm and block light with wavelengths shorter than about 490-500 nm. An ideal blue filter may transmit light with wavelengths shorter than about 480-500 nm.

Anaglyph viewing filters are typically comprised of adsorption dyes and/or pigments. These adsorption materials generally have broad adsorption spectra that constrain the transmission spectra of the viewing filters. The leading manufacturers of color adsorption filters typically publish swatch books with sample filters that may represent hundreds of different adsorption spectra. The typical method of selecting filters for anaglyph glasses involves trying combinations of the published filters and perhaps having a custom filter made that is an interpolation of the published spectra. Typically, each choice of filters is a tradeoff between brightness (high transmission of desired primary colors) and ghosting (transmission of undesired primary colors). Generally, it is assumed that increasing the ghosting and brightness of a filter also improves the color gamut viewed through the filter. Although, there is not a consensus (among experimenters) as to which filters are optimal, manufacturers of 3D glasses tend to settle on specific filters.

Due to the broad adsorption spectra of adsorption materials, the transmission spectra of viewing filters of the prior art often leak substantial amounts of light of the opposite image near the transmission edges of the filters. This results in substantial ghosting of the opposite image through the filters. Cyan viewing filters of the prior art for viewing red/cyan anaglyphs generally leak substantial amounts of yellow and red light with wavelengths near 590-610 nm. Yellow viewing filters of the prior art for viewing blue/yellow anaglyphs generally leak substantial amounts of blue light with wavelengths near 480-500 nm. Magenta viewing filters of the prior art for viewing green/magenta anaglyphs generally leak substantial amounts of green light with wavelengths near 500-510 nm and 570-580 nm. Using greater amounts of adsorption material may reduce the amount of leaked light however the brightness of transmitted primary colors may also be reduced.

It is widely known that the range of perceived hues in anaglyphs may be expanded to some degree by choosing one or both of the viewing filters to partially transmit or leak a small amount of additional primary colors through the filters. For example, a red filter that also transmits a small amount of green light may allow a dark green hue and an unsaturated red hue to be perceived through the red filter. Or a cyan filter that also transmits a small amount of red light may allow a dark red hue and an unsaturated cyan hue to be perceived through the filter.

Transmitting part of the primary colors of the opposite image through a viewing filter may cause the user to see ghost images or double images in the stereo view. The double images may reduce the ability of the user to fuse the stereo pair and may reduce the perceived stereoscopic depth in the stereo view. Therefore, when using leaky filters, the benefit of the extra hues created by the leak is accompanied by the disadvantage of perceiving less stereoscopic depth.

Conventional cyan filters comprised of adsorption materials for viewing red/cyan anaglyphs are often leak a small amount of a red primary color through the filter. This allows a weak reddish hue to be perceived through the cyan filter. However the leaked red primary color creates a ghost of the second image in the view of the first image. Furthermore since the second image is often offset from the first image due to stereoscopic parallax, the red light from the second image is not always at the proper location to contribute correctly to the color of the first image. In effect the added hues due to the leak cause the hues in the stereo view to be scrambled or jumbled. Similar disadvantages occur when using leaky filters with blue/yellow and green/magenta anaglyphs.

The broad adsorption spectra of adsorbing filters may substantially reduce the brightness of the primary colors observed through the viewing filters. For example in order for a blue filter to adequately block green light, a blue filter comprised of adsorption material may also attenuate about 80 percent of a blue primary color. Similarly, a magenta filter may attenuate about 80 percent of a blue primary color, a green filter may attenuate about 50 percent of a green primary color, and a cyan filter may attenuate about 50 percent of green and blue primary colors.

The broad adsorption spectra of adsorption materials used in anaglyph viewing filters of the prior art result in characteristic problems in various types of anaglyphs. Red/cyan anaglyph viewing filters typically have substantial ghosting of the red primary color through the cyan filter, substantial ghosting of the green primary color through the red filter, and the brightness of the first cyan image may be significantly brighter that the second red image when viewed through the viewing filters. Green/magenta viewing filters typically have substantial attenuation of blue light through the magenta filter. Blue/yellow viewing filters typically have substantial ghosting of green light and substantial attenuation of the blue light through the blue filter.

Color filters of the prior art for viewing anaglyph images are often comprised of flexible polymer films and adsorption dyes or pigments. The polymer films are often less a few mils thick and comprised of polyester or some other transparent polymer. The flexible polymer films are a low cost means to contain or support the adsorption materials. The flexible films are often mounted in inexpensive paper frames in order minimize the cost of the viewing glasses.

Dichroic filters are comprised of thin layers deposited on a substrate. The layers may preferentially reflect certain ranges of wavelengths due to the interference effects of the layers. Dichroic interference layers are typically deposited on relatively thick substrates. The layers are often comprised of metal-oxides with varying chemical composition. The metal oxides are generally formed by chemical reaction during deposition. The deposited layers are typically rigid and cannot withstand significant bending. Therefore rigid substrates such as glass or plastic are typically used for depositing interference layers. In order to obtain a high degree of control over the transmission spectra, the composition and thickness of each layer may need to be controlled accurately. The layers are deposited one at a time on substrates in vacuum chambers while the thickness of a layer may be monitored in real time. Dichroic filters are typically produced in batches whose size depends on the size of the vacuum chamber. These manufacturing methods are relatively expensive. Also the substrate adds substantially to the material cost of the dichroic filters. The substrates are typically much heavier than adsorption films and typically require heavier frames to hold the filters.

Anaglyph glasses (filters and frames) are often distributed with anaglyph content such as movie DVD's or printed images. Anaglyph viewing filters are often mounted in paper frames that may be easily packaged with DVD's (or other optical storage media), and with printed media. For example, paper anaglyph glasses are often distributed as a magazine insert. Paper frames also allow promotional content to be printed on the printable areas of the paper frames. In contrast, dichroic filters typically require rigid frames that are not easily packaged with various media and are not as easily printed on and are often too expensive for some applications. In addition, dichroic filters may be 100 to 5000 times more expensive than typical adsorption filters used for viewing anaglyph images making them unsuitable for many applications.

Dichroic filters have been used in the prior art to view stereoscopic images (six-color anaglyphs) rendered in six primary colors where a first image is rendered in first red R₁, green G₁, and blue B₁ primary colors and a second image is rendered in second red R₂, green G₂, and blue B₂ primary colors.

Dichroic filters typically reflect the light that is not passed by the filter. When using dichroic filters for viewing stereoscopic images, light incident on the ocular side of the viewing filters may reflect into a user's eyes. The reflected light may partially obscure the view of the stereoscopic images through the filter. In order to reduce the reflections of light from behind a user, the glass or plastic substrates of the dichroic filters may be curved. However, depositing interference layers on curved substrates may add to the cost of the filters. Also depositing interference layers on curved surfaces is often problematic due to the resulting variations in layer thickness that may depend on the orientation of the substrate surface during deposition.

Therefore, there is a need for improved filters for viewing anaglyph images with increased transmission efficiency of transmitted primary colors and reduced ghosting of blocked primary colors, and having relatively low cost and weight, which may be packaged and distributed in lightweight frames such as paper frames.

### BRIEF SUMMARY OF THE INVENTION

The present invention is directed to the use of interference films and adsorption films to provide color filters with high transmission efficiency, low cost, and low weight for viewing anaglyph images.

Some aspects of the present invention concern the use of interference layers to improve the spectra of colored filters for viewing anaglyph images in order to improve the brightness of the transmitted primary colors, and reduce the ghosting of blocked primary colors. Some aspects of the present invention concern viewing apparatus comprised of thin, plastic interference films in order to provide improved brightness and low ghosting at low cost.

### BRIEF DESCRIPTION OF THE SEVERAL VIEWS OF THE DRAWING

FIG. 1 depicts paper frames and first and second interference filters.

FIG. 2A depicts the transmission spectra of an ideal cyan interference filter 204, a cyan adsorption filter of the prior art 202, and a cyan polymer interference filter 206 of the present invention.

FIG. 2B depicts the transmission spectra of an ideal red interference filter 214, a red adsorption filter of the prior art 212, and a red polymer interference filter 216 of the present invention.

FIG. 3 depicts an interference film passing some light and reflecting other light incident on the ocular and the objective surfaces of the film.

FIG. 4 depicts an interference film and an adsorption film wherein the interference film passes some light and reflects other light incident on the ocular and objective surfaces and wherein the adsorption film adsorbs some of the reflected light on the ocular side of the interference film.

FIG. 5A may depict the transmission spectrum of an ideal interference film and the transmission spectrum of an adsorption film 504 of the present invention and the transmission spectrum of an adsorption film 506 of the prior art for viewing images rendered in green and blue primary colors.

FIG. 5B may depict the combined transmission spectrum 510 of an ideal interference film and an adsorption film of the present invention and the transmission spectrum 506 of an adsorption film of the prior art for viewing images rendered in green and blue primary colors.

FIG. 5C may depict the reflection spectrum 514 of an ideal interference film of the present invention and the transmission spectrum 504 of an adsorption film of the present invention for viewing images rendered in green and blue primary colors.

FIG. 6A may depict the transmission spectrum of an ideal interference film 602 and the transmission spectrum of an adsorption film 604 of the present invention and the transmission spectrum an adsorption film 606 of the prior art for viewing images rendered in a red primary color.

FIG. 6B may depict the combined transmission spectrum 610 of an ideal interference film and an adsorption film of the present invention and the transmission spectrum 606 of an adsorption film of the prior art for viewing images rendered in a red primary color.

FIG. 6C may depict the reflection spectrum 614 of an ideal interference film of the present invention and the transmission spectrum 604 of an adsorption film of the present invention for viewing images rendered in a red primary color.

FIG. 7A may depict the transmission spectrum of an ideal interference film 702 and the transmission spectrum an adsorption film 704 of the present invention and the transmission spectrum an adsorption film 706 of the prior art for viewing images rendered in red and blue primary colors.

FIG. 7B may depict the combined transmission spectrum 710 of an ideal interference film and an adsorption film of the present invention and the transmission spectrum 706 of an adsorption film of the prior art for viewing images rendered in red and blue primary colors.

FIG. 7C may depict the reflection spectrum 714 of an ideal interference film of the present invention and the transmission spectrum 704 of an adsorption film of the present invention for viewing images rendered in red and blue primary colors.

FIG. 8A may depict the transmission spectrum of an ideal interference film 802 and an adsorption film 804 of the present invention and the transmission spectrum of an adsorption film 806 of the prior art for viewing images rendered in a green primary color.

FIG. 8B may depict the combined transmission spectrum 810 of an ideal interference film and an adsorption film of the present invention and the transmission spectrum 806 of an adsorption film of the prior art for viewing images rendered in a green primary color.

FIG. 8C may depict the reflection spectrum 814 of an ideal interference film of the present invention and the transmission spectrum 804 of an adsorption film of the present invention for viewing images rendered in a green primary color.

FIG. 9 may depict the transmission spectrum of an ideal interference film 902 and the transmission spectrum of an adsorption film 904 of the present invention and an adsorption film 906 of the prior art for viewing images rendered in a green primary color.

FIG. 10 depicts curved frames providing the first and second flexible filters with a curved profile.

FIG. 11 depicts a flexible interference film laminated to a substrate providing the interference film with a curved profile.

### DETAILED DESCRIPTION OF THE INVENTION

### Anaglyphic Viewing Apparatus

The present invention provides apparatus for viewing anaglyph images comprising thin, polymer interference films. The polymer interference films may be less than a few mils thick and may be mounted in paper frames a distance d apart for viewing anaglyph images. The interference films may comprise layers of polymer material such as polyester and acrylic with various thicknesses and different refractive indices. The interference layers may be self-supporting while not requiring a supporting substrate. The anaglyph viewing apparatus of the present invention may be produced utilizing conventional mass production methods that may include printing, die cutting, gluing and laminating. The polymer interference films may be used with adsorption materials to provide the benefits of the embodiments described below. The polymer interference films may be combined with adsorption material by lamination, adjacent positioning, coating, or dyeing of the interference film. The polymer interference films of the present invention may be used in one filter of a viewing apparatus to view one image of a stereoscopic image while not being used in a second filter for viewing the opposite image. The viewing apparatus of the present invention may provide increased transmission of transmitted primary colors, reduced leakage of blocked primary colors, material costs and distribution means similar to paper glasses of the prior art comprising adsorption films.

The polymer interference filters of the present invention may be produced by co-extrusion of multiple layers in a continuous web process. A manifold with multiple feed sources may form a flow of polymer material consisting of multiple layers of polymer with different or alternating refractive indices. Varying the flow rates of the multiple feed sources, among other processing variables, may be used to control the relative thicknesses of the layers. The layers may become progressively thinner as the flow becomes narrower by stretching or squeezing. This method of manufacture of interference layers may allow hundreds or thousands of layers to be formed at low cost. However the individual layers of the polymer interference film are usually much less controllable than the layers of dichroic filters resulting in variable layer and film thicknesses and variable transmission spectra across the width of a web and as a function of time (longitudinal position on the film). For this reason, the spectra of polymer interference filters are typically more variable, less predictable or less controllable than dichroic (deposited metal-oxide) filters commonly used for precise control of color transmission and color rendering. However, the high number of layers of the polymer interference films allows a relatively simple layer structure (design) requiring less relative control of layer thicknesses for some purposes. Any other method of the prior art for producing polymer interference films may be used to produce the films of the present invention.

Dichroic filters are commonly used to filter light and produce primary colors in display devices. For accurate color production in display devices, it is considered important to have a high degree of control and lack of variation of the spectra of the interference filters. Polymer interference films of the present invention may have comparatively large variations in the relative transmission of various primary colors.

The polymer interference films of the present invention effectively produce or modify the primary colors presented to the user's eyes. For this application, the problems of color variation are reduced by the properties anaglyphs and of human vision.

There are two relevant differences in the way that color is perceived in anaglyph images compared with non-stereoscopic applications, which ameliorate the variable transmission spectra of the polymer interference films of the present invention. in the use of the interference filters for viewing anaglyphs compared with viewing non-stereoscopic images on a display device. First, when viewing anaglyph image through viewing filters, the viewing filters typically modify the spectrum of the entire field of view of the user. This results in the opponent color functions used in human vision adapting to the spectrum available to the user's eye. Therefore, variances in the filter spectra may be compensated for by the adaptation of the user's visual system so that similar colors may be observed through films with substantially different spectra. In contrast, when viewing a 2D display, the user's eyes may be constantly exposed to the spectrum of light of the environment. Therefore, the user's eyes remain adapted to the surrounding light rather than to the display device. Therefore it is more critical that the primary colors of a 2D display have consistent primary colors than the primary colors of anaglyph images.

A second difference between using interference filters in viewing apparatus versus in display devices is that in anaglyph viewing apparatus, the filters may remain relatively fixed with respect to a user's eyes. Therefore, the viewing angles through the filters of the 3D glasses of the present invention have a small range where color variation, as a function of viewing angle may be small.

The present invention benefits from these special features of anaglyph viewing in order to provide improved perceived color in anaglyph images using inexpensive polymer interference films.

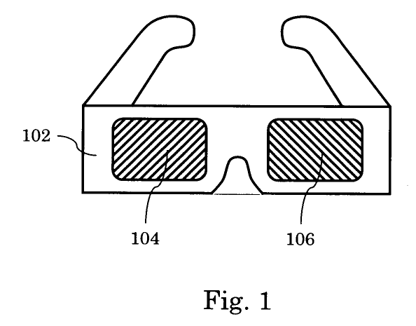

FIG. 1 depicts one embodiment of the viewing apparatus of the present invention. The first filter 104 and the second filter 106 are mounted in paper frames 102 a distance d apart. Either the first or second filter or both may be comprised of a polymer interference film.

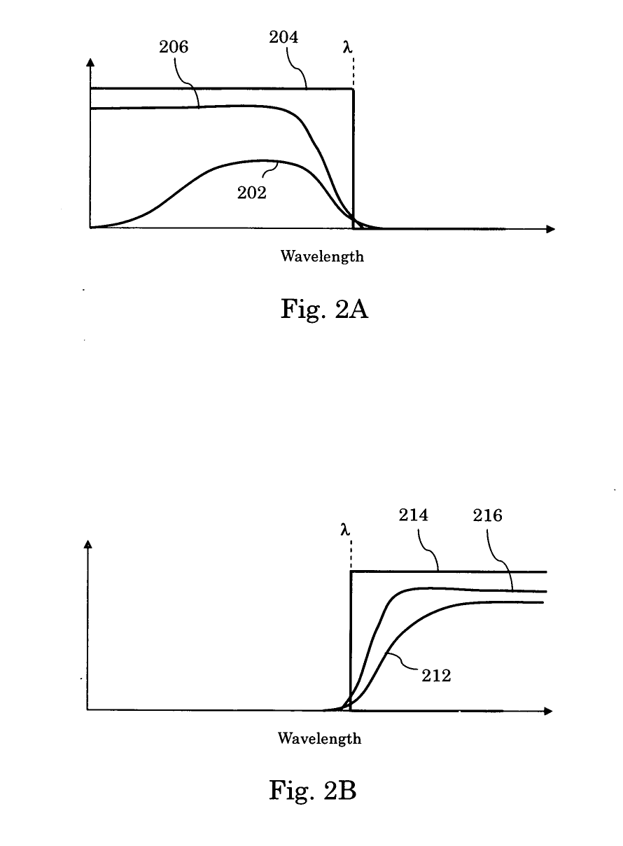

FIGS. 2A and 2B compare typical transmission spectra of convention red and cyan adsorption filters with ideal interference filters and realistic polymer interference filters. FIG. 2A depicts the relatively inefficient transmission spectrum 202 of a cyan adsorption filter, the highly efficient transmission spectrum 204 of an ideal interference filter, and the intermediately efficient transmission spectrum 206 of a polymer interference filter. For clarity of description and to elucidate the advantages of interference films, the embodiments below which combine an interference film with an adsorption film are often illustrated using an ideal interference spectrum. However, the scope of the present invention and disclosure should be viewed with regard to using non-ideal interference films such as polymer interference films with adsorption films in order to obtain similar advantages. Some aspects of the present invention may apply to any type of interference film. Interference films have the property that the primary colors blocked by the film may be substantially reflected by the layers rather than being adsorbed. Adsorption films may be used to preferentially adsorb the reflected light form the interference films. The adsorption film f₃ may be adjacent to and optically cooperating with the interference film f₁. Preferably the adsorption film f₃ may be positioned on the ocular side of a filter relative to the interference film f₁ in order that the reflected light into a user's eye may be attenuated.

One embodiment of the present invention provides an apparatus for viewing anaglyph stereoscopic images comprising a frame and color filters. A first filter may be used to view a first image of a stereoscopic pair with a user's first eye while a second filter may be used to view a second image of a stereoscopic pair with a user's second eye. The first filter may substantially pass the primary colors of the first image and block the primary colors of the second image. The second filter may substantially pass the primary colors of the second image and block the primary colors of the first image. The color filters may be comprised of polymer interference filters. The interference filters of the present invention may be comprised of interference layers with various thicknesses and refractive indices. One method of producing the interference filters of the present invention is by extruding polymer through an extrusion manifold by establishing a flow comprised of layers of polymers with various refractive indices and thicknesses. The thickness of the interference filter may be as thin as the multiple-layer stack of the interference layers. In other words, a substrate may not be required to support the interference layers. The filters may be less than about a few mils thick or comparable to the thickness of typical dye film filters used in the prior art for viewing anaglyph images. The filters of the present invention may be produced in large flat sheets and may be cut to size to make filters for mounting into frames.

The viewing filters of the present invention may be mounted in rigid frames or in flexible frames such as frames comprised of paper. The viewing filters may be mounted distance d apart for viewing anaglyph images. The frames may be wearable or designed to be used handheld. The frames may provide the filters with a flat or curved profile. The frames may flex the filters into a curved profile. Or the filters of the present invention may be provided with a curved profile by laminating the interference films to a second flexible plastic film with a slightly different differential length. The difference in differential lengths of the second film compared with the interference film may determine the curved profile of the combined film or filter. Or the films of the present invention may be adjacent or laminated to a rigid substrate comprised of for example plastic or glass, which may have a flat or curved surface.

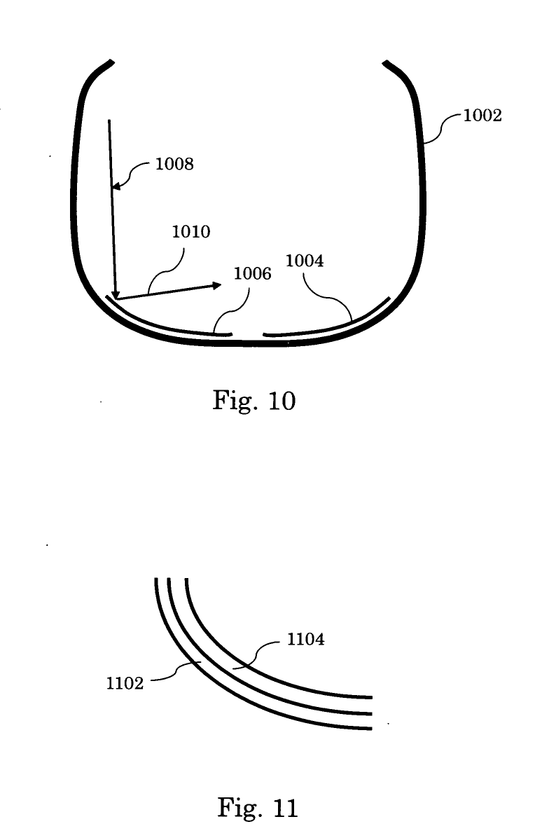

FIG. 10 may depict a first filter 1004 and a second filter 1006 of the present invention mounted in rigid frame 1002. At least one of the first and second filters may be comprised of polymer interference films. The first filter F₁ may be comprised of a first film f₁ having a thickness comparable to thickness of the stack of interference layers or less than a few mils thick. The second filter F₂ may be comprised of a second film f₂ having a thickness comparable to thickness of the stack of interference layers or less than a few mils thick. The rigid frame may provide the filters with a curved profiles whereby light 1008 incident on the ocular side of the filter originating from behind a user may substantially not be reflected into the eyes of the user. The reflected light rays 1010 are depicted in FIG. 10. FIG. 11 depicts a flexible interference film 1102 of the present invention laminated to a substrate 1104 whereby the filter has a curved profile. The interference film 1102 and the second film 1104 may be laminated together using a curved fixture in order to obtain the desired curved profile.

The filters of the present invention may be manufactured with transmission spectra appropriate for viewing red/cyan, blue/yellow, and green/magenta anaglyph images. Furthermore, the filters of the present invention may be manufactured with transmission spectra appropriate for viewing anaglyph images rendered in more than three primary colors. If the first image of an anaglyph is rendered in primary colors {P₁, . . . , Pₘ} and the second image of an anaglyph is rendered in primary colors {Q₁, . . . , Qₙ}, the first viewing filter of the present invention may substantially pass primary colors {P₁, . . . , Pₘ} and block primary colors {Q₁, . . . , Qₙ}; and the second viewing filter of the present invention may substantially pass primary colors {Q₁, . . . , Qₙ} and block primary colors {P₁, . . . , Pₘ}. Common cases are (m=2; n=1), (m=3, n=1), and (m=3, n=3), but other cases are included in the scope of the present invention.

For red/cyan anaglyphs, the primary colors {P₁, . . . , Pₘ} may consist of green and blue primary colors and the {Q₁, . . . , Qₙ} primary colors may consist of a red primary color. A red primary color may comprise wavelengths longer than about 590 nm. The green and blue primary colors may comprise wavelengths shorter than about 590 nm.

In blue/yellow anaglyphs, the primary colors {P₁, . . . , Pₘ} may consist of red and green primary colors and the {Q₁, . . . , Qₙ} primary colors may consist of a blue primary color. A blue primary color may comprise wavelengths shorter than about 480 nm to 500 nm. The green and red primary colors may comprise wavelengths longer than about 480 nm to 500 nm.

In green/magenta anaglyphs, the primary colors {P₁, . . . , Pₘ} may consist of red and blue primary colors and the {Q₁, . . . , Qₙ} primary colors may consist of a green primary color. A green primary color may comprise wavelengths between about 480 nm to 500 nm and about 590 nm. The blue and red primary colors may comprise wavelengths longer than about 590 nm and wavelengths shorter than about 480 nm to 500 nm.

In yellow/RGB anaglyphs, the primary colors {P₁, . . . , Pₘ} may consist of red, green and blue primary colors and the {Q₁, . . . , Qₙ} primary colors may consist of a yellow primary color. A yellow primary color may comprise wavelengths longer than about 550 nm to 570 nm and shorter than about 580 nm to 620 nm. Red, green and blue primary colors may comprise wavelengths shorter than about 550 nm to 570 nm and wavelengths longer than about 580 nm to 620 nm.

In red/YGB anaglyphs, the primary colors {P₁, . . . , Pₘ} may consist of yellow, green and blue primary colors and the {Q₁, . . . , Qₙ} primary colors may consist of a red primary color. A red primary color may comprise wavelengths longer than about 590 nm to 620 nm. Yellow, green, a blue primary colors may comprise wavelengths shorter than about 580 nm to 620 nm.

In cyan/RGB anaglyphs, the primary colors {P₁, . . . , Pₘ} may consist of red, green and blue primary colors and the {Q₁, . . . , Qₙ} primary colors may consist of a cyan primary color. A cyan primary color may comprise wavelengths between about 470 nm to about 520 nm. Blue, green and red primary colors may comprise wavelengths shorter than about 470 nm and wavelengths longer than about 520 nm.

In yellow-cyan/RGB anaglyphs, the primary colors {P₁, . . . , Pₘ} may consist of red, green and blue primary colors and the {Q₁, . . . , Qₙ} primary colors may consist of yellow and cyan primary colors. Yellow and cyan primary colors may comprise wavelengths between about 470 nm and 510 nm and wavelengths between about 560 nm and about 610 nm. Red, green and blue primary colors may comprise wavelengths shorter than about 460 nm to 480 nm and wavelengths between about 510 nm and about 550 nm to 570 nm and wavelengths longer than about 590 nm to 610 nm.

In white/RGB anaglyphs, the primary colors {P₁, . . . , Pₘ} may consist of red, green and blue primary colors and the {Q₁, . . . , Qₙ} primary colors may consist of a white primary colors. A white primary color may comprise wavelengths near about 480 nm and near about 580 nm. Red, green and blue primary colors may comprise wavelengths shorter than about 460 nm to 480 nm and wavelengths between about 510 nm and about 550 nm to 570 nm and wavelengths longer than about 590 nm to 610 nm.

In RGB/RGB anaglyphs, the primary colors {P₁, . . . , Pₘ} may consist of first red R₁, green G₁, and blue B₂ primary colors and the {Q₁, . . . , Qₙ} primary colors may consist of second red R₂, green G₂, and blue B₂, primary colors. The spectra of the first red, green, and blue primary colors may substantially not overlap the spectra of the second red, green, and blue primary colors.

The interference filters of the present invention may provide brighter views of anaglyph images than dye filters having similar spectral ranges. In addition, the interference filters of the present invention may provide substantially less ghosting than dye filters with similar brightness. The interference filters of the present invention may be of similar weight as adsorption dye films while being substantially less expensive and lighter than dichroic filters deposited on glass or plastic substrates. Therefore, the present invention provides brighter anaglyph views with less ghosting than the prior art while providing the low cost advantages comparable to dye filters. In some embodiments of the present invention, interference films may be adjacent or laminated to or deposited on a rigid substrate comprised of for example plastic or glass material.

### Interference Films and Adsorption Films

Some embodiments of the present invention provide a method to view anaglyph images using color filters comprising interference films and adsorption films. The interference films of the present invention may be adjacent to and optically cooperating with an adsorption film. In the present embodiment, the interference films may be used to provide high efficiency transmission of the transmitted primary colors and effective reflection of the blocked primary colors while the adsorption films may be used to attenuate reflected light from the interference layers. In these embodiments, the interference films of the present invention may include interference layers deposited on thick substrates or thin extruded polymer interference layers.

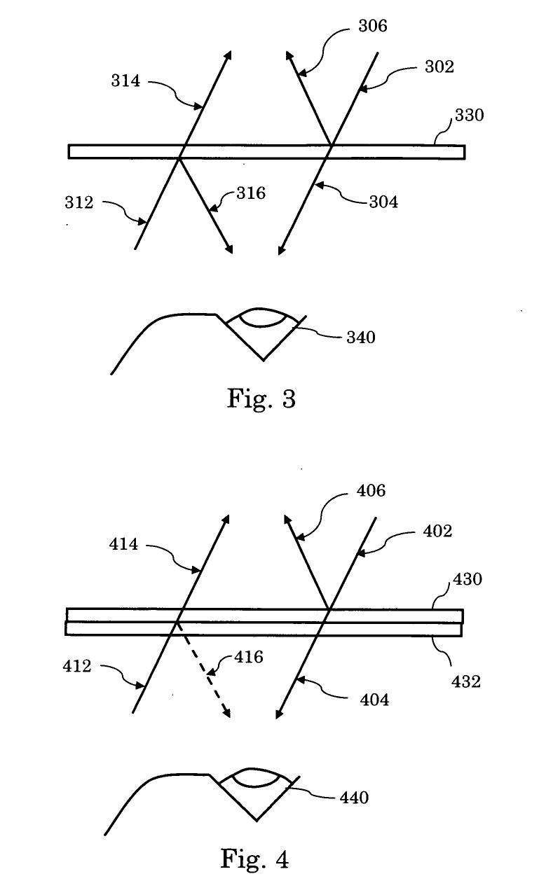

FIG. 3 depicts the action of an interference film 330 of the present invention on incident light. Incident light 302 on the objective side of the film may be selectively transmitted or reflected by the interference film. The light 304 of some primary colors may be substantially transmitted while the light 306 of other primary colors may be substantially reflected by the interference film. Similarly, incident light 312 on the ocular side of the film may be selectively transmitted or reflected by the interference film. The light 314 of some primary colors may be substantially transmitted while the light 316 of other primary colors may be substantially reflected by the interference film. The reflected light 316 from the ocular side of the film may be undesirably directed toward the user's eye 340 which may interfere with the view of the images. Therefore, it is desirable to attenuate the reflected light 316 from the ocular side of the interference films of the present invention.

In some embodiments of the present invention, the light reflected toward a user's eyes from the interference film may be reduced by adsorption films on the ocular side of the interference films. The interference films may be adjacent to adsorption films wherein the adsorption films are on the ocular side of the filters. The light incident on the ocular side of the interference film and reflected into the user's eye may first travel through the adsorption film toward the interference film, then travel through the adsorption film a second time toward the user. The double pass through the adsorption film may substantially attenuate the reflected light toward the user. Light incident on the ocular side of the filter may be partially adsorbed by the adsorption film and partially reflected by the interference film. The reflected light may be partially adsorbed by the adsorption film while a fraction of the reflected light may pass toward the user's eyes. Ideally, the adsorption spectra of the adsorption films may be substantially similar to the reflection spectra of the interference films. Then the reflected wavelengths of light may be uniformly attenuated by the adsorption dyes. However in practice, the adsorption spectra of dyes are typically less sharp than the reflection spectra of the interference films. In this case, the adsorption film may typically not adsorb all reflected wavelengths of light with similar efficiency. For example near the transmission edges, the reflected light may not be adsorbed as completely by the adsorption films as the light further from the transmission edges. However, even in this case, the adsorption films may attenuate the reflected light by a large fraction.

FIG. 4 depicts the action of an interference film 430 and adsorption film 432 of the present invention on incident light. Incident light 402 on the objective side of the film may be selectively transmitted or reflected by the interference film. The light 404 of some primary colors may be substantially transmitted while light 406 of other primary colors may be substantially reflected by the interference film. Similarly, incident light 412 on the ocular side of the film may be selectively transmitted or reflected by the interference film. The light 414 of some primary colors may be substantially transmitted while the light 416 of other primary colors may be substantially reflected by the interference film. The adsorption film 432 may attenuate the light 416 reflected on the ocular side of the interference film. The adsorption dye may have a transmission spectrum that preferentially adsorbs the primary colors of the reflected light 416. Then, the reflected light 416 may be attenuated by a large fraction while the transmitted light 404 is attenuated by a much small fraction.

### Red/Cyan Anaglyph Filters

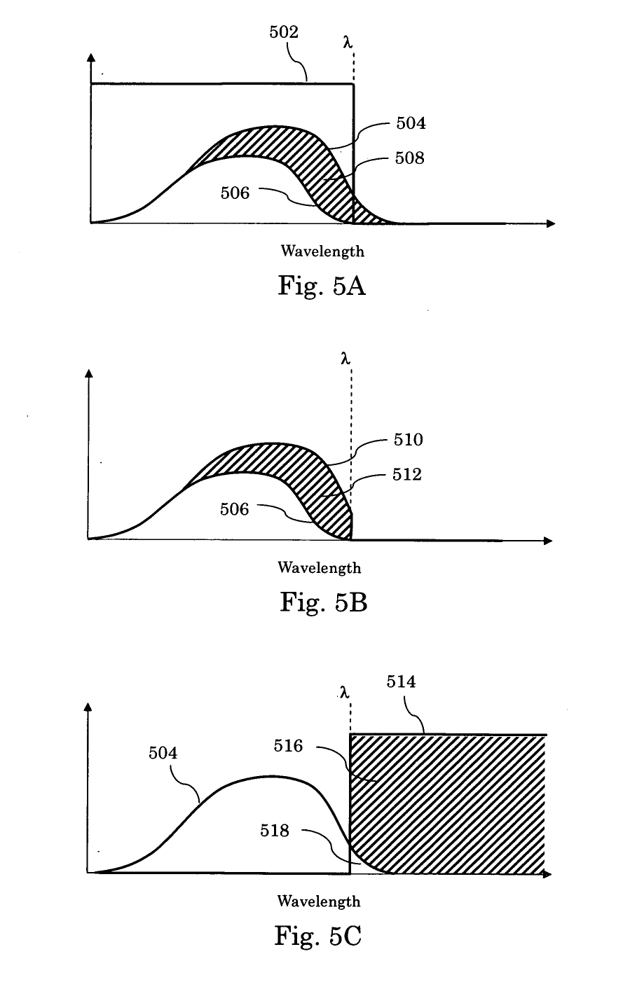

With FIGS. 5a-c may depict the action of an ideal interference film and an adsorption film of a cyan filter of the present invention used for viewing red/cyan anaglyphs. In FIG. 5a-c, transmission, reflection and adsorption spectra are depicted schematically with respect to a wavelength λ. In regard to red/cyan anaglyphs, λ may be about 590 nm. FIG. 5a may depict the transmission spectra 502 of an ideal interference film used to pass green and blue primary colors and to block a red primary color. FIG. 5a also may depict the transmission spectra 504 of an adsorption film of the present invention used to attenuate red reflections; and the transmission spectra 506 of a cyan dye filter of the prior art. FIG. 5b may depict the combined transmission spectra 510 of an ideal interference film and the adsorption film of a cyan filter of the present invention; and the transmission spectra 506 of a cyan dye filter of the prior art. The shaded region 512 in FIG. 5b may depict the increased brightness of the cyan filter of the present invention compared with the cyan filter of the prior art. FIG. 5c may depict the inflection spectra 514 of an ideal interference film of the present invention and the transmission spectra 504 of an adsorption film of the present invention. Although the reflected light may travel twice through the adsorption film of the present invention, the shaded region 516 may roughly represent the attenuated portion of the reflected light. The un-shaded region 518 under the spectrum 504 and to the right of wavelength λ in FIG. 5c may roughly represent the portion of reflected light directed toward the user's eye.

FIGS. 5a-c illustrate the advantages of combining an ideal interference film with an adsorption film comprising a cyan filter. The advantages comprise increasing the brightness of transmitted green and blue primary colors while attenuating a reflected red primary color compared with either dye filters or interference filters alone. Similar advantages may be provided by embodiments of the present invention comprising non-ideal interference films and adsorption films.

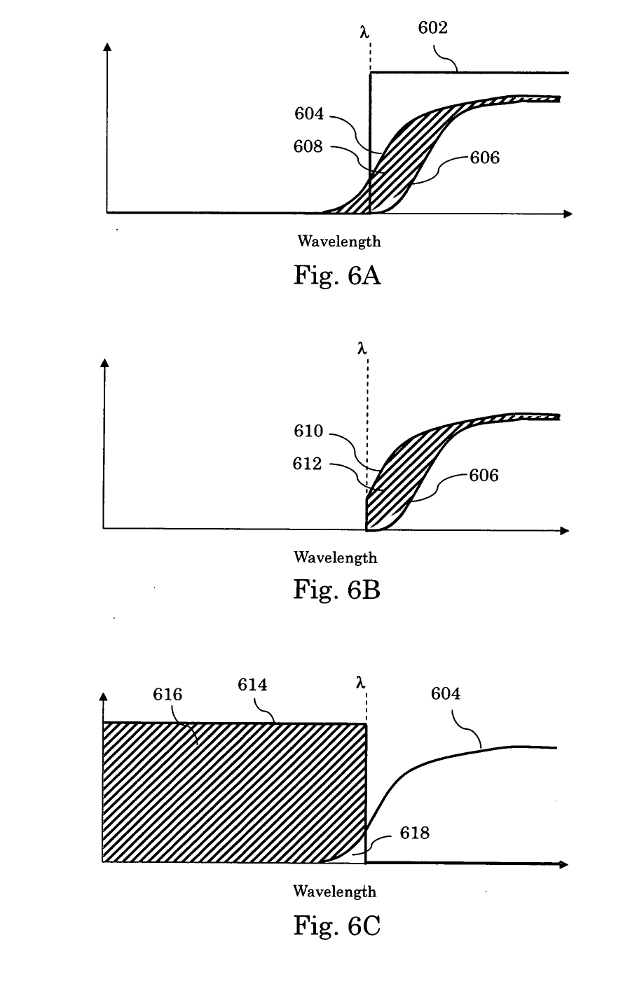

With FIGS. 6a-c may depict the action of an ideal interference film and an adsorption film of a red filter of the present invention used for viewing red/cyan anaglyphs. In FIG. 6a-c, transmission, reflection and adsorption spectra are depicted schematically with respect to a wavelength λ. In regard to red/cyan anaglyphs, λ may be about 590 nm. FIG. 6a may depict the transmission spectra 602 of an ideal interference film used to pass a red primary color and to block green and blue primary colors. FIG. 6a also may depict the transmission spectra 604 of an adsorption film of the present invention used to attenuate green and blue reflections; and the transmission spectra 606 of a red dye filter of the prior art. FIG. 6b may depict the combined transmission spectra 610 of an ideal interference film and the adsorption film of a red filter of the present invention; and the transmission spectra 606 of a red dye filter of the prior art. The shaded region 612 in FIG. 6b may depict the increased brightness of the red filter of the present invention compared with the red filter of the prior art. FIG. 6c may depict the inflection spectra 614 of an ideal interference film of the present invention and the transmission spectra 604 of an adsorption film of the present invention. Although the reflected light may travel twice through the adsorption film of the present invention, the shaded region 616 may roughly represent the attenuated portion of the reflected light. The un-shaded region 618 under the spectrum 604 and to the left of wavelength λ in FIG. 6c may roughly represent the portion of reflected light directed toward the user's eye.

FIGS. 6a-c illustrate the advantages of combining an ideal interference film with an adsorption film comprising a red filter. The advantages comprise increasing the brightness of transmitted red primary color while attenuating reflected green and blue primary colors compared with either dye filters or interference filters alone. Similar advantages may be provided by embodiments of the present invention comprising non-ideal interference films and adsorption films.

### Blue/Yellow Anaglyph Filters

With FIGS. 5a-c may depict the action of an ideal interference film and an adsorption film of a blue filter of the present invention used for viewing blue/yellow anaglyphs. In FIG. 5a-c, transmission, reflection and adsorption spectra are depicted schematically with respect to a wavelength λ. In regard to blue/yellow anaglyphs, λ may be about 490 nm. FIG. 5a may depict the transmission spectra 502 of an ideal interference film used to pass a blue primary color and to block red and green primary colors. FIG. 5a also may depict the transmission spectra 504 of an adsorption film of the present invention used to attenuate red and green reflections; and the transmission spectra 506 of a blue dye filter of the prior art. FIG. 5b may depict the combined transmission spectra 510 of an ideal interference film and the adsorption film of a blue filter of the present invention; and the transmission spectra 506 of a blue dye filter of the prior art. The shaded region 512 in FIG. 5b may depict the increased brightness of the blue filter of the present invention compared with the blue filter of the prior art. FIG. 5c may depict the inflection spectra 514 of an ideal interference film of the present invention and the transmission spectra 504 of an adsorption film of the present invention. Although the reflected light may travel twice through the adsorption film of the present invention, the shaded region 516 may roughly represent the attenuated portion of the reflected light. The un-shaded region 518 under the spectrum 504 and to the right of wavelength λ, in FIG. 5c may roughly represent the portion of reflected light directed toward the user's eye.

FIGS. 5a-c illustrate the advantages of combining an ideal interference film with a dye film comprising a blue filter. The advantages comprise increasing the brightness of transmitted blue primary color while attenuating reflected green and red primary colors compared with either dye filters or interference filters alone. Similar advantages may be provided by embodiments of the present invention comprising non-ideal interference films and adsorption films.

FIGS. 6a-c may depict the action of an ideal interference film and an adsorption film of a yellow filter of the present invention used for viewing blue/yellow anaglyphs. In FIG. 6a-c, transmission, reflection and adsorption spectra are depicted schematically with respect to a wavelength λ. In regard to blue/yellow anaglyphs, λ, may be about 490 nm. FIG. 6a may depict the transmission spectra 602 of an ideal interference film used to pass red and green primary colors and to block a blue primary color. FIG. 6a also may depict the transmission spectra 604 of an adsorption film of the present invention used to attenuate blue reflections; and the transmission spectra 606 of a yellow dye filter of the prior art. FIG. 6b may depict the combined transmission spectra 610 of an ideal interference film and the adsorption film of a yellow filter of the present invention; and the transmission spectra 606 of yellow dye film of the prior art. The shaded region 612 in FIG. 6b may depict the increased brightness of the yellow filter of the present invention compared with the yellow filter of the prior art. FIG. 6c may depict the inflection spectra 614 of an ideal interference film of the present invention and the transmission spectra 604 of an adsorption film of the present invention. Although the reflected light may travel twice through the adsorption film of the present invention, the shaded region 616 may roughly represent the attenuated portion of the reflected light. The un-shaded region 618 under the spectrum 604 and to the left of wavelength λ in FIG. 6c may roughly represent the portion of reflected light directed toward the user's eye.

FIGS. 6a-c demonstrate the advantages of combining an ideal interference film with an adsorption film comprising a yellow filter. The advantages comprise increasing the brightness of transmitted green and red primary colors while attenuating a reflected blue primary color compared with either dye filters or interference filters alone. Similar advantages may be provided by embodiments of the present invention comprising non-ideal interference films and adsorption films.

### Green/Magenta Anaglyph Filters

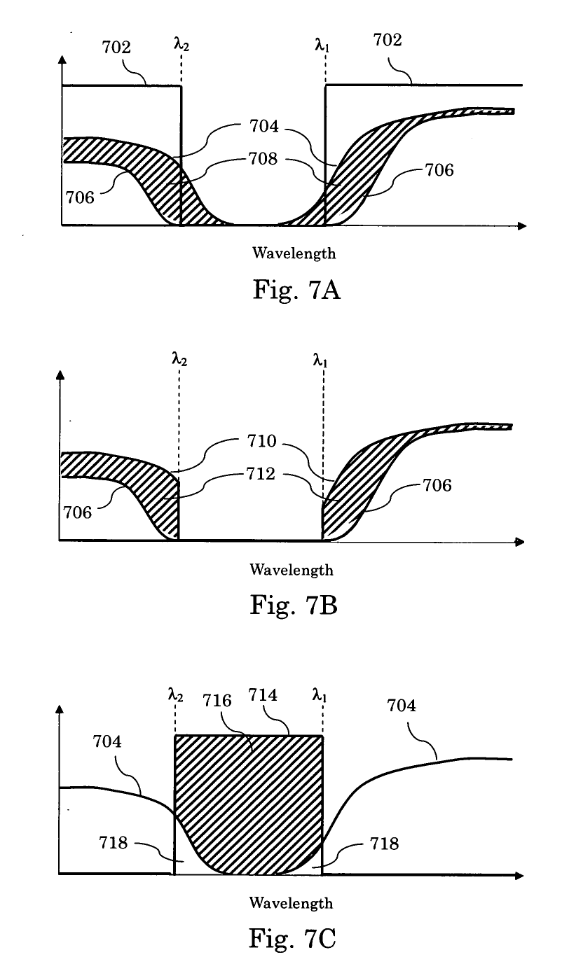

With FIGS. 7a-c may depict the action of an ideal interference film and an adsorption film of a magenta filter of the present invention used for viewing green/magenta anaglyphs. In FIG. 7a-c, transmission, reflection and adsorption spectra are depicted schematically with respect to a first wavelength λ₁ and a second wavelength λ₂. In regard to green/magenta anaglyphs, λ₁ may be about 490 nm and λ₂ may be about 590 nm. FIG. 7a may depict the transmission spectra 702 of an ideal interference film used to pass red and blue primary colors and to block a green primary color. FIG. 7a also may depict the transmission spectra 704 of an adsorption film of the present invention used to attenuate green reflections; and the transmission spectra 706 of a magenta dye filter of the prior art. FIG. 7b may depict the combined transmission spectra 710 of an ideal interference film and the adsorption film of a magenta filter of the present invention; and the transmission spectra 706 of a magenta dye filter of the prior art. The shaded region 712 in FIG. 7b may depict the increased brightness of the magenta filter of the present invention compared with the magenta filter of the prior art. FIG. 7c may depict the inflection spectra 714 of an ideal interference film of the present invention and the transmission spectra 704 of an adsorption film of the present invention. Although the reflected light may travel twice through the adsorption film of the present invention, the shaded region 716 may roughly represent the attenuated portion of the reflected light. The un-shaded region 718 under the spectrum 704 and between wavelength λ₁ and wavelength λ₂ in FIG. 7c may roughly represent the portion of reflected light directed toward the user's eye.

FIGS. 7a-c illustrate the advantages of combining an ideal interference film with an adsorption film comprising a magenta filter. The advantages comprise increasing the brightness of transmitted blue and red primary colors while attenuating a reflected green primary color compared with either dye filters or interference filters alone. Similar advantages may be provided by embodiments of the present invention comprising non-ideal interference films and adsorption films.

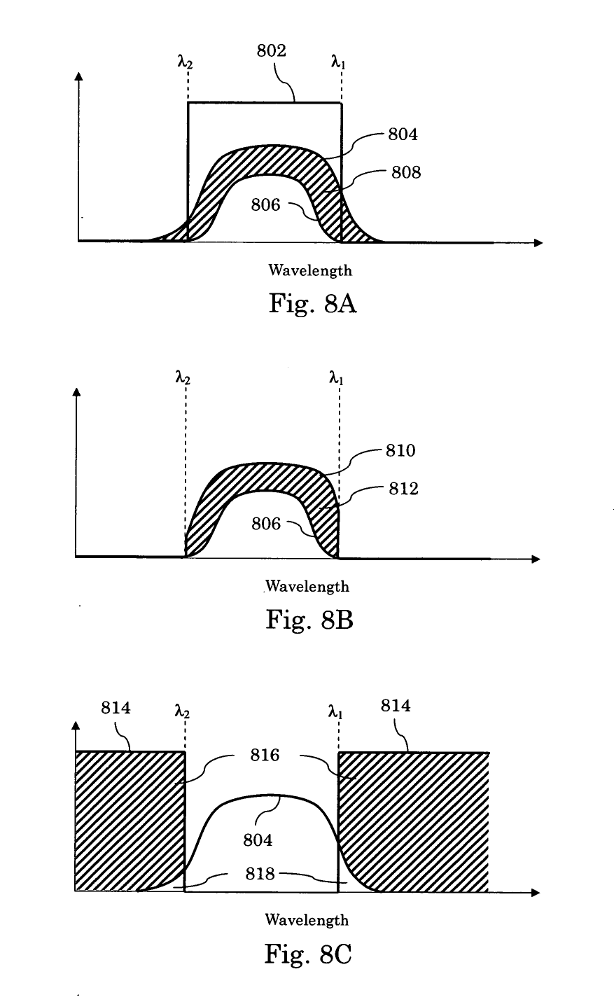

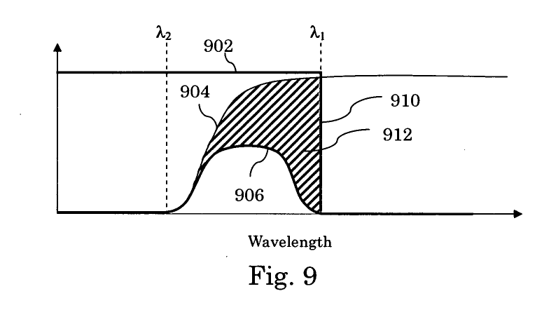

With FIGS. 8a-c may depict the action of an ideal interference film and an adsorption film of a green filter of the present invention used for viewing green/magenta anaglyphs. In FIG. 8a-c, transmission, reflection and adsorption spectra are depicted schematically with respect to a first wavelength λ₁ and a second wavelength λ₂. In regard to green/magenta anaglyphs, λ₁ may be about 490 nm and λ₂ may be about 590 nm. FIG. 8a may depict the transmission spectra 802 of an ideal interference film used to pass a green primary color and to block red and blue primary colors. FIG. 8a also may depict the transmission spectra 804 of an adsorption film of the present invention used to attenuate red and blue reflections; and the transmission spectra 806 of a green dye filter of the prior art. FIG. 8b may depict the combined transmission spectra 810 of an ideal interference film and the adsorption film of a green filter of the present invention; and the transmission spectra 806 of green dye film of the prior art. The shaded region 812 in FIG. 8b may depict the increased brightness of the green filter of the present invention compared with the green filter of the prior art. FIG. 8c may depict the inflection spectra 814 of an ideal interference film of the present invention and the transmission spectra 804 of an adsorption film of the present invention. Although the reflected light may travel twice through the adsorption film of the present invention, the shaded region 816 may roughly represent the attenuated portion of the reflected light. The un-shaded region 818 under the spectrum 804 and between wavelength λ₁ and wavelength λ₂ in FIG. 8c may roughly represent the portion of reflected light directed toward the user's eye.

FIGS. 8a-c illustrate the advantages of combining an ideal interference film with an adsorption film comprising a green filter. The advantages comprise increasing the brightness of transmitted green primary color while attenuating reflected blue and red primary colors compared with either dye filters or interference filters alone. Similar advantages may be provided by embodiments of the present invention comprising non-ideal interference films and adsorption films.

### Yellow/RGB Anaglyph Filters

With FIGS. 7a-c may depict the action of an ideal interference film and an adsorption film of an RGB filter of the present invention used for viewing yellow/RGB anaglyphs. In FIG. 7a-c, transmission, reflection and adsorption spectra are depicted schematically with respect to a first wavelength λ₁ and a second wavelength λ₂. In regard to yellow/RGB anaglyphs, λ₁ may be about 560 nm and λ₂ may be about 600 nm. FIG. 7a may depict the transmission spectra 702 of an ideal interference film used to pass red, green and blue primary colors and to block a yellow primary color. FIG. 7a also may depict the transmission spectra 704 of an adsorption film of the present invention used to attenuate yellow reflections; and the transmission spectra 706 of a RGB dye filter. FIG. 7b may depict the combined transmission spectra 710 of an ideal interference film and the adsorption film of an RGB filter of the present invention; and the transmission spectra 706 of an RGB dye filter. The shaded region 712 in FIG. 7b may depict the increased brightness of the RGB filter of the present invention compared with an RGB dye filter. FIG. 7c may depict the inflection spectra 714 of an ideal interference film of the present invention and the transmission spectra 704 of an adsorption film of the present invention. Although the reflected light may travel twice through the adsorption film of the present invention, the shaded region 716 may roughly represent the attenuated portion of the reflected light. The un-shaded region 718 under the spectrum 704 and between wavelength λ₁ and wavelength λ₂ in FIG. 7c may roughly represent the portion of reflected light directed toward the user's eye.

FIGS. 7a-c illustrate the advantages of combining an ideal interference film with an adsorption film comprising a RGB filter. The advantages comprise increasing the brightness of transmitted red, green and blue primary colors while attenuating a reflected yellow primary color compared with either dye filters or interference filters alone. Similar advantages may be provided by embodiments of the present invention comprising non-ideal interference films and adsorption films.

With FIGS. 8a-c may depict the action of an ideal interference film and an adsorption film of a yellow filter of the present invention used for viewing yellow/RGB anaglyphs. In FIG. 8a-c, transmission, reflection and adsorption spectra are depicted schematically with respect to a first wavelength λ₁ and a second wavelength λ₂. In regard to yellow/RGB anaglyphs, λ₁ may be about 560 nm and λ₂ may be about 600 nm. FIG. 8a may depict the transmission spectra 802 of an ideal interference film used to pass a yellow primary color and to block red, green and blue primary colors. FIG. 8a also may depict the transmission spectra 804 of an adsorption film of the present invention used to attenuate red, green and blue reflections; and the transmission spectra 806 of a yellow dye filter. FIG. 8b may depict the combined transmission spectra 810 of an ideal interference film and the adsorption film of a yellow filter of the present invention; and the transmission spectra 806 of yellow dye filter. The shaded region 812 in FIG. 8b may depict the increased brightness of the yellow filter of the present invention compared with a yellow dye filter. FIG. 8c may depict the inflection spectra 814 of an ideal interference film of the present invention and the transmission spectra 804 of an adsorption film of the present invention. Although the reflected light may travel twice through the adsorption film of the present invention, the shaded region 816 may roughly represent the attenuated portion of the reflected light. The un-shaded region 818 under the spectrum 804 and between wavelength λ₁ and wavelength λ₂ in FIG. 8c may roughly represent the portion of reflected light directed toward the user's eye.

FIGS. 8a-c illustrate the advantages of combining an ideal interference film with an adsorption film comprising a yellow filter. The advantages comprise increasing the brightness of transmitted yellow primary color while attenuating reflected red, green and blue primary colors compared with either dye filters or interference filters alone. Similar advantages may be provided by embodiments of the present invention comprising non-ideal interference films and adsorption films.

### Cyan/RGB Anaglyph Filters

With FIGS. 7a-c may depict the action of an ideal interference film and an adsorption film of an RGB filter of the present invention used for viewing cyan/RGB anaglyphs. In FIG. 7a-c, transmission, reflection and adsorption spectra are depicted schematically with respect to a first wavelength λ₁ and a second wavelength λ₂. In regard to cyan/RGB anaglyphs, λ₁ may be about 460 nm and λ₂ may be about 510 nm. FIG. 7a may depict the transmission spectra 702 of an ideal interference film used to pass red, green and blue primary colors and to block a cyan primary color. FIG. 7a also may depict the transmission spectra 704 of an adsorption film of the present invention used to attenuate cyan reflections; and the transmission spectra 706 of a RGB dye filter. FIG. 7b may depict the combined transmission spectra 710 of an ideal interference film and the adsorption film of an RGB filter of the present invention; and the transmission spectra 706 of an RGB dye filter. The shaded region 712 in FIG. 7b may depict the increased brightness of the RGB filter of the present invention compared with an RGB dye filter. FIG. 7c may depict the inflection spectra 714 of an ideal interference film of the present invention and the transmission spectra 704 of an adsorption film of the present invention. Although the reflected light may travel twice through the adsorption film of the present invention, the shaded region 716 may roughly represent the attenuated portion of the reflected light. The un-shaded region 718 under the spectrum 704 and between wavelength λ₁ and wavelength λ₂ in FIG. 7c may roughly represent the portion of reflected light directed toward the user's eye.

FIGS. 7a-c illustrate the advantages of combining an ideal interference film with an adsorption film comprising a RGB filter. The advantages comprise increasing the brightness of transmitted red, green and blue primary colors while attenuating a reflected cyan primary color compared with either dye filters or interference filters alone. Similar advantages may be provided by embodiments of the present invention comprising non-ideal interference films and adsorption films.

With FIGS. 8a-c may depict the action of an ideal interference film and an adsorption film of a cyan filter of the present invention used for viewing cyan/RGB anaglyphs. In FIG. 8a-c, transmission, reflection and adsorption spectra are depicted schematically with respect to a first wavelength λ₁ and a second wavelength λ₂. In regard to cyan/RGB anaglyphs, λ₁ may be about 460 nm and λ₂ may be about 510 nm. FIG. 8a may depict the transmission spectra 802 of an ideal interference film used to pass a cyan primary color and to block red, green and blue primary colors. FIG. 8a also may depict the transmission spectra 804 of an adsorption film of the present invention used to attenuate red, green and blue reflections; and the transmission spectra 806 of a cyan dye filter. FIG. 8b may depict the combined transmission spectra 810 of an ideal interference film and the adsorption film of a cyan filter of the present invention; and the transmission spectra 806 of cyan dye filter. The shaded region 812 in FIG. 8b may depict the increased brightness of the cyan filter of the present invention compared with a cyan dye filter. FIG. 8c may depict the inflection spectra 814 of an ideal interference film of the present invention and the transmission spectra 804 of an adsorption film of the present invention. Although the reflected light may travel twice through the adsorption film of the present invention, the shaded region 816 may roughly represent the attenuated portion of the reflected light. The un-shaded region 818 under the spectrum 804 and between wavelength λ₁ and wavelength λ₂ in FIG. 8c may roughly represent the portion of reflected light directed toward the user's eye.

FIGS. 8a-c illustrate the advantages of combining an ideal interference film with an adsorption film comprising a cyan filter. The advantages comprise increasing the brightness of transmitted cyan primary color while attenuating reflected red, green and blue primary colors compared with either dye filters or interference filters alone. Similar advantages may be provided by embodiments of the present invention comprising non-ideal interference films and adsorption films.

### More Green, Yellow and Cyan Filters

Several types of anaglyphs may be viewed using color filters having the characteristic of band pass filters. Band pass filter may pass a band of wavelengths while blocking wavelengths shorter and wavelengths longer than the band. The second image of green/magenta, yellow/RGB and cyan/RGB anaglyphs may be viewed using band pass filters for the second viewing filter. The present invention has several embodiments in which a band pass filter may be comprised of a short pass filter and a long pass filter. The transmission regions of the long and short pass filters may overlap in the transmission band of the band pass filter. The long pass filters may be provided by adsorption filters while the short pass filters may be provided interference filters. Short pass adsorption filters are typically not very efficient; therefore the present embodiments provide more efficient band filters than using adsorption filters alone.

Another embodiment of the present invention provides a green filter comprised of a short pass interference film and a long pass adsorption film for viewing the green images of green/magenta anaglyphs. The short pass interference film may transmit light with wavelengths less than about 570 nm to 600 nm and reflect light with wavelengths greater than about 570 nm to 600 nm. The adsorption film may transmit light with wavelengths greater than about 470 nm to 500 nm and adsorb light with wavelengths shorter than about 470 nm to 500 nm. The adsorption film may be adjacent to and optically cooperating with the interference film. The adsorption film may be on the ocular side of the filter whereby a substantial portion of the reflected light with wavelengths less than about 470 nm to 500 nm may be adsorbed.

Another embodiment of the present invention provides a yellow filter comprised of a short pass interference film and a long pass adsorption film for viewing the yellow images of yellow/RGB anaglyphs. The short pass interference film may transmit light with wavelengths less than about 590 nm to 620 nm and reflect light with wavelengths greater than about 590 nm to 620 nm. The adsorption film may transmit light with wavelengths greater than about 550 nm to 570 nm and adsorb light with wavelengths shorter than about 550 nm to 570 nm. The adsorption film may be adjacent to and optically cooperating with the interference film. The adsorption film may be on the ocular side of the filter whereby a substantial portion of the reflected light with wavelengths less than about 550 nm to 570 nm may be adsorbed.

Another embodiment of the present invention provides a cyan filter comprised of a short pass interference film and a long pass adsorption film for viewing the cyan images of cyan/RGB anaglyphs. The short pass interference film may transmit light with wavelengths less than about 490 nm to 520 nm and reflect light with wavelengths greater than about 490 nm to 520 nm. The adsorption film may transmit light with wavelengths greater than about 460 nm to 480 nm and adsorb light with wavelengths shorter than about 460 nm to 480 nm. The adsorption film may be adjacent to and optically cooperating with the interference film. The adsorption film may be on the ocular side of the filter whereby a substantial portion of the reflected light with wavelengths less than about 460 nm to 480 nm may be adsorbed.

In alternative embodiments of the green, yellow and cyan filters described immediately above, the long-pass adsorption films may provide substantial absorption of light with wavelengths longer than the transmission band thereby adsorbing a greater portion of the reflected light from the interference film. For example, the adsorption films comprising the green and cyan filters may adsorb a substantial amount of red light in order to attenuate the reflected red light from the interference films.

The present invention may include use adsorption dyes to improve the efficiency of the interference films of the viewing filters described herein. It is beneficial for the viewing filters to pass light in certain ranges of wavelength and effectively block light in certain ranges of wavelength. Adsorption dyes may be used to improve the blocking of light in certain ranges of wavelength. For example, an interference filter may be used to provide sharp blocking edges while an adsorption filter is used to provide broad regions of blocked wavelengths. In another example, an interference film may be used to provide sharp blocking edges on two sides of a band pass filter while an adsorption dye is used to provide broad regions of blocked wavelengths. Certain natural oscillations in interference layer designs may be exploited to form sharp blocking edges in a band pass filter of the present invention. Furthermore, two dichroic films may be used with an adsorption film in order to provide filters with broader regions of blocked wavelengths.

As noted above, the present invention is applicable to interference films, adsorption films, and primary colors and is believed to be particularly useful for displaying and viewing stereoscopic images in various anaglyphic formats. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

I claim:

1. An apparatus for viewing anaglyphic stereoscopic images comprising:
a first polymer film f₁;
a second polymer film f₂;
a frame;
film f₁ and film f₂ mountable in said frame a distance d apart for viewing anaglyphic images;
film f₁ substantially transmitting m primary colors {P₁, . . . , Pₘ};
film f₂ substantially transmitting n primary colors {Q₁, . . . , Qₙ};
film f₁ substantially reflecting primary color Q₁;
film f₂ substantially blocking primary color P₁;
the spectrum of primary color P₁ not substantially overlapping the spectra of primary colors {Q₁, . . . , Qₙ}; and
the spectrum of primary color Q₁ not substantially overlapping the spectra of primary colors (P₁, . . . , Pₘ); and
n plus m greater than or equal to 3.

2. The apparatus of claim 1 wherein film f₁ comprises interference layers with various refractive indices and thicknesses.

3. The apparatus of claim 1 wherein film f₁ comprises alternating layers of polyester and acrylic polymer.

4. The apparatus of claim 1 wherein: film f₁ may be produced by a structured flow through an extrusion manifold.

5. The apparatus of claim 1 wherein: primary color Q₁ is red, yellow, green, cyan, blue or white.

6. The apparatus of claim 1 wherein: primary color Q₁ comprises wavelengths longer than about 590 nm to 610 nm.

7. The apparatus of claim 1 wherein: primary color Q₁ comprises wavelengths longer than about 550 nm to 570 nm and shorter than about 590 nm to 610 nm.

8. The apparatus of claim 1 wherein: primary color Q₁ comprises wavelengths longer than about 480 nm to 510 nm and shorter than about 560 nm to 590 nm.

9. The apparatus of claim 1 wherein: primary color Q₁ comprises wavelengths longer than about 460 nm to 480 nm and shorter than about 500 nm to 520 nm.

10. The apparatus of claim 1 wherein: primary color Q₁ comprises wavelengths shorter than about 450 nm to 490 nm.

11. The apparatus of claim 1 further comprising:
a third film f₃;
film f₃ adjacent to and optically cooperating with film f₁; and
film f₃ adsorbing a substantial fraction of primary color Q₁.

12. The apparatus of claim 2 wherein film f₂ substantially reflects primary color P₁.

13. The apparatus of claim 1 further comprising:
a fourth film f₄;
film f₄ adjacent to and optically cooperating with film f₂; and
film f₄ adsorbing a substantial fraction of primary color P₁.

14. The apparatus of claim 1 wherein said frame is comprised of paper.

15. An apparatus for viewing anaglyphic stereoscopic images comprising:
a first polymer interference film f₁;
a second film f₂; and
a frame, said first and second films mountable in said frame for viewing anaglyphic stereoscopic images.

16. The apparatus of claim 15 wherein:
the thickness of film f₁ is less than a few mils; and
the thickness of film f₂ is less than a few mils.

17. The apparatus of claim 15 wherein said frame is comprised of paper.

18. The apparatus of claim 15 wherein said frame is rigid.

19. The apparatus of claim 15 wherein:
film f₁ has a curved profile; and
film f₂ has a curved profile.

20. The apparatus of claim 15 further comprising:
a third adsorption film f₃ adjacent to and optically cooperating with film f₁.

21. The apparatus of claim 15 further comprising:
a fourth adsorption film f₄ adjacent to and optically cooperating with film f₂;
and wherein film f₂ is a polymer interference film

23. The apparatus of claim 20 wherein:
film f₃ is positioned on the ocular side of film f₁.

24. The apparatus of claim 15 further comprising:
a first rigid substrate;
a second rigid substrate;
said first film laminated to said first substrate; and
said second film laminated to said second substrate.

25. Apparatus for viewing anaglyphic stereoscopic images comprising:
a first interference film;
a second interference film;
a first adsorption film;
a second adsorption film;
said first interference film adjacent to and optically cooperating with said first adsorption film;
said second interference film adjacent to and optically cooperating with said second adsorption film;
a frame;
said first interference film and first adsorption film mountable in said frame a distance d apart for viewing a first image of an anaglyphic stereoscopic image;
said second interference film and second adsorption film mounted in said frame for viewing a second image of said anaglyphic stereoscopic image;
said first interference film substantially transmitting primary colors {P₁, . . . , Pₘ} and reflecting primary colors {Q₁, . . . , Qₙ}; and
said second interference film substantially transmitting primary colors {Q₁, . . . , Qₙ} and reflecting primary colors {P₁, . . . , Pₘ}.

26. The apparatus of claim 25 wherein:
said first adsorption film preferentially adsorbs the primary colors {Q₁, . . . , Qₙ}; and
said second adsorption film preferentially adsorbs the primary colors {P₁, . . . , Pₘ}.

27. The apparatus of claim 25 wherein:
the thickness of said first interference film is less than a few mils; and
the thickness of said second interference film is less than a few mils.

28. The apparatus of claim 25 wherein said frame is comprised of paper.

29. The apparatus of claim 25 wherein said frame is rigid.

30. The spectacles of claim 25 wherein:
said first interference film has a curved profile; and
said second interference film has a curved profile.
